(19) United States
(12) Patent Application Publication
(10) Pub. No.: US 2016/0071399 A1
(43) Pub. Date: Mar. 10, 2016

(54) PERSONAL SECURITY SYSTEM

(71) Applicant: On Guard LLC, La Jolla, CA (US)

(72) Inventors: Steven ALTMAN, La Jolla, CA (US); Zachary RATTNER, La Jolla, CA (US)

(73) Assignee: On Guard LLC, La Jolla, CA (US)

(21) Appl. No.: 14/731,913

(22) Filed: Jun. 5, 2015

Related U.S. Application Data
(60) Provisional application No. 62/047,419, filed on Sep. 8, 2014.

(51) Int. Cl. G08B 25/01; G10L 15/00

(52) U.S. Cl. CPC G08B 25/016; G10L 15/00

(57) ABSTRACT

A personal security system that continually monitors audio from any microphone accessible from a computer or mobile phone for keys, identifies keys emitted by a user and if found, issues an alert. May also monitor movement to aid in event detection. Audio monitoring may search for keys in a personalized manner to minimize false positives and may work on low power devices in the background to continually provide security, even if a computer is locked. May transmit alerts via a data network, or voice network. The alerts may be sent to users, devices, security or medical entities to provide personal safety and security. May also be utilized for persons unable to physically manipulate their phone or computer, during or after an assault, or medical emergency. May also be utilized to improve safety when moving between locations, to improve the safety of a driver or a passenger of a vehicle.

This patent application claims the benefit of U.S. Provisional Patent Application Ser. No. 62/047,419 filed 8 Sep. 2014, the specification of which is hereby incorporated herein by reference.

### BACKGROUND OF THE INVENTION

1. Field of the Invention

Embodiments of the invention generally relate to a personal security system that monitors audio and generates alerts. Embodiments monitor audio, for example continually and when the computer is in any state of readiness. The audio is analyzed to identify a key emitted by a user and if found, an alert is generated without requiring manual contact or manipulation of the computer. Embodiments may also monitor movement to aid in event detection. Embodiments enable individuals to generate an alert or make a phone call even if they are unable to physically manipulate their mobile phone, for example during or after an assault, or medical emergency.

2. Description of the Related Art

There are a variety of situations when an event occurs, such as a threat, assault or other emergency event, which affects the safety of individuals. For example, many individuals find themselves in harms way as potential or actual victims of crime, sexual assault, and medical emergencies. At times, the individuals may not have time to call for help, or be able to get up and walk to a phone, or may not have use of their hands to manipulate a phone.

Traditional means of contacting a third party during an emergency include dialing an emergency number such as 911 in the United States to access an emergency response system. Other means, for example, include stand-alone devices having police or 911 buttons, wherein an emergency call is communicated to the third party and in some instances a light flashes if an alert is initiated by the individual. This type of solution generally requires physical manipulation of the device to transmit an alert. Furthermore, these types of products may put the individual, or victim at risk when attempting to seek assistance if a perpetrator is aware of the individual's attempt to seek assistance.

Typically, personal mobile devices worn or carried by an individual allow the individual's location to be tracked using a location services feature by transmitting the detected location of the individual to the third party. However, mobile devices generally require the individual to manually unlock and manually operate the mobile device in order to initiate an alert or call for help. The individual in this scenario may not have time or the physical ability to initiate an alert.

In other known mobile device solutions, an individual may place their thumb on a screen of a mobile device, and once the device detects wherein the thumb is lifted off of the screen, the device automatically generates a phone call. This requires that the individual know that an assault or medical emergency is going to occur and also requires the individual to have the ability to reach the mobile device, unlock the mobile device and manually operate the mobile device, which may not be possible or timely.

Other non-alert based voice command devices, such as the Amazon Echo®, generally require continuous power to operate and are generally immobile. These devices may control items in the house, but require a user to be in proximity to the device, which is generally plugged into a particular wall socket and hence not available for use as an alert device if the user is in another room. As of yet, these types of devices are not capable of generating alerts.

Generally, victims of assault, sexual abuse or medical emergencies may not have time, or may not be able to find, see, reach, unlock or otherwise manipulate their mobile device. The victim may also be injured and may lack the physical abilities to use their mobile devices. Thus, the victim may be unable to call for help, for example call 911, or alert another individual not located nearby. Typically, current mobile devices and emergency alert systems are limited in range and in the number of third party individuals to contact. In general, these devices require physical human manipulation to operate. In addition, when using such devices and systems, the individual may place themselves at greater risk by alerting a perpetrator when attempting to notify a third party or while seeking assistance.

Known systems assume that the victim will correctly suspect that they are about to become a victim of a crime or accident or that they are able to manipulate their phones after the crime or accident occurs. However, many crimes or accidents occur when the victim least suspects it.

In addition, there are a variety of potential situations where a threat to the safety of a driver or passenger of a vehicle occurs. Known solutions discussed above may be utilized in a vehicle scenario, but have the same limitations listed above. Hence, it would be desirable to provide a system for protecting and providing an extra level of security for drivers or passengers, including taxi and limo and ride share services. It would also be desirable to provide a system that provides the driver or passenger with extra security whether in the vehicle or outside of the vehicle.

For example, U.S. Pat. No. 8,624,727, entitled “Personal Safety Mobile Notification System”, to Saigh et al., discloses a system that establishes a perimeter around an area, and using mobile devices within the perimeter, communicates information with a server. According to Saigh et al., the mobile devices may enable users to plan actions or take routes through safest routes provided to the mobile devices. However, the system of Saigh et al. appears to lack any teaching or suggestion of collecting audio data, recognizing a key therefrom as obtained from a user, and generating an alert based on the key.

United States Patent Publication 20120319840, entitled “Systems and Methods to Activate a Security Protocol Using n Object with Embedded Safety Technology”, to Amis, appears to disclose means for initiating a distress signal by knocking over an object embedded with a safety device. According to Amis, when the safety device senses movement of the object, the safety device transmits a distress signal to a third party and initiates various events in the environment surrounding the object to deter, delay or disrupt a perpetrator. However, the system of Amis appears to lack any teaching or suggestion of collecting audio data, recognizing a key therefrom as obtained from a user, and generating an alert based on the key.

For example, U.S. Pat. No. 8,630,820, entitled “Methods and Systems for Threat Assessment, Safety Management, and Monitoring of Individuals and Groups”, to Amis, appears to disclose methods and systems to anticipate potentially threatening or dangerous incidents and provide varying levels of response to a user, such as prior to, during and after an incident. According to Amis, for example, the varying levels of response may provide assistance to the user including deterrents, alerting other personnel, sending security personnel to the scene, monitoring the scene, and interacting with the scene or user. However, the system of Amis appears to lack any teaching or suggestion of collecting audio data, recognizing a key therefrom as obtained from a user, and generating an alert based on the key.

U.S. Pat. No. 8,472,915, entitled “Emergency Personal Protection System Integrated with Mobile Devices”, to DiPerna et al., appears to disclose a mobile device capable of obtaining an image data, audio data and location data, to transmit the data. According to DiPerna et al., for example, the system includes a panic button that activates a camera, location unit, transmitting unit and a self-defense mechanism. However, the system of DiPerna et al. appears to lack any teaching or suggestion of collecting audio data, recognizing a key therefrom as obtained from a user, and generating an alert based on the key.

For example, United States Patent Publication 20140329491, entitled “ProtectEM (Domestic Abuse and Emergency App)” to Scott, appears to disclose a mobile application that provides emergency services to individuals during domestic abuse, rape, kidnapping, sexual assaults, etc. According to Scott, the application may also be embedded into wearable devices or accessories that may be activated during an emergency to alert emergency responders. In addition, according to Scott, the application may beam the wearer's location, and allow the device to start taking pictures of the attacker or immediate surrounding and start recording audio to understand the nature of the attack. The system appears to require physical interaction with the device, which may not always be possible. The system of Scott appears to lack any teaching or suggestion of collecting audio data, recognizing a key therefrom as obtained from a user, and generating an alert based on the key.

In view of the above, there is a need for a personal security system that provides protection by at least audio key detection to enable individuals to easily alert or otherwise communicate with a third party when an emergency occurs, such as an assault by a potential perpetrator, or a medical emergency and even if the individual cannot physically manipulate their mobile device, or computer.

### BRIEF SUMMARY OF THE INVENTION

Embodiments of the invention generally relate to a personal security system that monitors audio and generates alerts. Embodiments monitor audio from any microphone accessible from a computer, for example continually and when the computer is in any state of readiness, for example locked, unlocked, in a minimal power setting, asleep, or in any other state to provide robust security. The audio is analyzed to identify a key emitted by a user and if found, issues an alert. Embodiments may monitor audio, identify keys and generate alerts without manual contact or manipulation of the computer. The computer may include a mobile phone, mobile device, tablet, any type of computer or any microphone that may couple with any type of computer. Embodiments may also monitor movement to aid in event detection. The alerts may be displayed or sounded locally, sent to users, devices, security or medical entities, or any combination thereof. Embodiments enable individuals to generate an alert even if they are unable to physically manipulate their mobile phone, for example during or after an assault, or medical emergency. In one or more embodiments, the alarm is set off locally to draw attention to the individual that has asserted the key to set off the alarm. This alarm may include flashing lights, vibration, and/or an alarm sound.

One or more embodiments include an application that may be executed on the computer. The computer may be associated with a particular individual or user, for example a mobile phone, or autonomous, such as any computer or security system with a microphone. Embodiments of the computer generally include a transmitter, a receiver, and a processor coupled with the transmitter and the receiver. Although mobile devices are utilized ubiquitously, any other type of computer coupled with a microphone may be utilized with the system to listen for keys. Example embodiments of the computer include, but are not limited to, a tablet computer, laptop computer, desktop computer, server computer, security computer, television, radio, vehicle, car radio, car phone, phone, alarm clock, watch, smart watch, appliance, vehicle, wireless microphone or any other computing device that has or can couple with a microphone whether mobile or stationary. In one or more embodiments, the processor collects audio data over time, for example samples audio in the background while the mobile device has power, even when the mobile device is locked, unlocked, idle, asleep, or is in any other state.

In at least one embodiment, when the processor detects a key for that individual, an alert is asserted or generated. The key may include any word, phrase or other sound and may be accepted from the individual to assert an alert. In one or more embodiments, the audio patterns and/or characteristics of the individual user may be utilized to verify that the key was emitted from that particular user and not another user. In this scenario, the system does not assert an alert unless the key matches the audio characteristics of a particular individual to prevent false positives.

By way of at least one embodiment of the invention, the application executes continually on the processor to collect data, such as audio data and optionally movement data from an accelerometer, gyroscope, or other inertial, triangulation, tactile, proximity or position sensor associated with the computer or user. In at least one embodiment, the application executes when the computer is on, when the computer is locked, unlocked, asleep, or in any other state so long as the application can run. Other sensors that may be utilized with embodiments of the invention include physiological sensors, to correlate a potential event with an individual's heart rate, blood pressure or other characteristics. The application may execute without any indication on the screen of the computer or mobile device, to listen continuously, or to listen at predefined intervals or in any other manner. According to at least one embodiment, the data, such as the audio data or movement data, may be collected at predefined intervals or substantially continually, time to time, or as often as is needed to detect a key for example. In at least one embodiment, the predefined intervals may include a fixed sampling rate or one or more sampling rates. In one or more embodiments, the application may alter the fixed sampling rate or the one or more sampling rates to use less or more power based on one or more of a time of day or location of the user. For example, a low sampling rate may be utilized during the day, and a higher sampling rate may be utilized when a processor is in a dangerous area or at a dangerous location. Lower sampling rates may be utilized in safer areas or times, or in quieter areas to conserve power in mobile devices. The sampling may have uniform or non-uniform time intervals between samples. The sampling may be performed by a low power co-processor or on any other processor and the main processor may be put into a lower power state for example in one or more embodiments.

In at least one embodiment of the invention, the application may execute on the processor to extract one or more features from the data, wherein the features may include characteristics of at least one word, phrase or sound obtained from the user. In one or more embodiments, the application may execute on the processor to recognize a key from the at least one word, phrase or sound, and generate an alert upon recognition of the key, for example by matching characteristics of the key. Example matching algorithms may include use of frequency ranges and durations thereof that define a pattern related to the key. In one or more embodiments, the processor may assert an alert locally through audio, visual, or tactile elements, or transmit the alert via the transmitter to a remote server or second user. One or more embodiments may provide the alert locally and remotely. Other embodiments may purposefully provide a remote alert without a local alert and notify security personal of a dangerous situation. Other embodiments enable an assault victim or elderly person who cannot reach their mobile phone or computer to send an alert in the form of a voice call directly from the user without requiring the individual to contact or manipulate the phone. Other embodiments may send acoustic samples from a predefined period before and/or after the alert to security or medical personnel or any other user or entity.

By way of at least one embodiment, the computer may include or may be coupled with at least one audio sensor, coupled directly or remotely with the processor, wherein the application collects the audio data via the at least one audio sensor. In at least one embodiment, the at least one audio sensor may include a remote or wireless microphone that transmits the audio data to the computer. In at least one embodiment, the computer may include a security system computer with a remote audio sensor that captures the audio data. In one or more embodiments, the system may include a low power co-processor coupled with the processor, wherein the application executes on the low power co-processor. In at least one embodiment, when the application executes on the low power co-processor, the processor is powered off, is switched into low power mode or is switched into sleep mode. In at least one embodiment, the application executes in a background mode. In one or more embodiments, the application executes on the processor to collect the data without manual interaction with the computer by the user.

In one or more embodiments, the data may include motion data, wherein the features include at least one movement associated with the user. In at least one embodiments, the computer may include at least one motion sensor coupled with the processor, wherein the application collects the motion data via the at least one motion sensor. In one or more embodiments, the one or more features may include a combination of a second key obtained from the user and the at least one movement associated with the user, wherein the combination occurs within a predetermined time window. This embodiment enables a startled individual to yell or scream proceeded by, at the same time, or followed by movement, that is indicative of a security event that warrants generation of an alert. In scenarios where an assailant startles the user and the user does not have time to say the predefined first key, this enables a level of robust protection for the user.

In at least one embodiment of the invention, the application may execute on the processor to filter noise from the data before the application extracts the one or more features from the data. Any other audio signal processing may be utilized, including any low power algorithms that may find keys. Higher accuracy algorithms may be switched in using a strategy pattern during high danger areas or times for example albeit with high power drain on a mobile device batter. Lower accuracy and lower power algorithms may be utilized in safer areas or times or in quieter environments to conserve power.

According to one or more embodiments of the invention, the application may accept the at least one word, phrase or sound in a plurality of intonations from the user. In at least one embodiment, the system compares the at least one word, phrase or sound in a plurality of intonations against characteristics of the first user to eliminate false positives. False positive elimination is utilized to ignore close but different non-key audio from a user or from others, or the same key created by other users. In the audio scenario this would include eliminating a lower pitched user's audio that has the correct key, but with a lower pitch or slower enunciation or different harmonics for example. In one or more embodiments, the user trains the system by speaking the key in a startled voice as if under duress, in a normal voice and in a whispering voice. In this manner the system may determine characteristics of the key under varying volumes to simplify the detection algorithm.

False positive elimination may also be utilized in tactile or movement based scenarios as well to eliminate keys entered by others, but with different characteristics. For a motion based key, comparison to a particular movement by a user may take the not only the number of movements, but also the timing between each movement, orientation during each movement or any other quantity associated with the gesture based key. For tapping or other proximity type keys that include a number of taps, the time between each tap and amplitude of each tap may form the characteristics that identify the key.

One or more embodiments may include a server. In at least one embodiment, the server may combine the key, e.g., at least one word, phrase or sound with predefined types of noise to generate training data. In one or more embodiments, the server may transmit the training data to the computer to generate a trained model that is personalized to the first user. In at least one embodiment, the training data may include sample data, wherein each of the sample data include an algorithmically defined pattern and code associated with the characteristics of the at least one word, phrase or sound. In one or more embodiments, the computer sends the key to the server and the server combines the key, optionally after pre-processing the key to vary the echo conditions, and combines the phrase with the noise. The server can then analyze the speech mixed against the various noise models to train the recognizer. The extracted features can be sent back to the computer for real-time processing.

By way of one or more embodiments, the application may include a voice recognition algorithm. In one or more embodiments, the system may continually determine the type of environmental sound that is occurring and attempt to match audio data with keys that also include that type of noise.

In at least one embodiment, the step of recognizing the key from the at least one word, phrase or sound includes a comparison of the at least one word, phrase or sound to the trained model to determine whether the at least one word, phrase or sound correlates with the trained model. In one or more embodiments, the trained model may be generated and personalized by the first user within the application via the processor. In at least one embodiment, the trained model may be generated and personalized by the first user via the server, and may be downloaded onto the computer. In at least one embodiment of the invention, when the at least one word, phrase or sound does not correlate with the trained model, the application, via the processor, continues to collect the data. In at least one embodiment, when the at least one word, phrase or sound does correlate with the trained model, the application generates the alert, and the processor transmits the alert via the transmitter. Use of a trained model enables lower power algorithms targeted at the individual so as to eliminate false positive keys emitted by another user.

According to one or more embodiments of the invention, the data collected may include an algorithmically defined pattern and code, wherein the application determines whether the at least one word, phrase or sound correlates with the trained model by comparing the pattern and code of the data to the pattern and code of the sample data.

In one or more embodiments of the invention, the server may include a selection database. In one or more embodiments, the server is located remote to the computer, and, the application bidirectionally communicates with the server. In at least one embodiment, the selection database includes contact information associated with a plurality of second users associated with the first user. In at least one embodiment of the invention, the application may include a plurality of phone numbers associated with the plurality of second users.

In one or more embodiments, when the application generates the alert, the application determines whether a data service is available via the computer, whether a voice service is available via the computer, or both. In at least one embodiment, when the data service is available, the application transmits the alert to the server via the processor and the transmitter, the server receives the alert, and when the server receives the alert, the server selects a second user from the at least one second user associated with the first user, and transmits a notification to the second user. For example, in at least one embodiment, the second user may include a guardian, a parent, other relative if the parent is not nearby, security personnel, government officials, school campus personnel, etc. In one or more embodiments, when the voice service is available, for example when the application determines wherein the data service is unavailable, the application selects a phone number from the plurality of phone numbers associated with the at least one second user and initiates a voice call to the at least one second user.

By way of at least one embodiment, the server may select the second user from the at least one second user, and/or the application may select the phone number from the plurality of phone numbers associated with the at least one second user, based on which of the at least one second user is deemed most likely to be able to respond to the notification. In one or more embodiments, which of the at least one second user is deemed most likely to be able to respond to the notification is based on one or more parameters selected from a location of the first user, a time of day, a location of the at least one second user, and, a presence or absence of the at least one second user located within a predetermined vicinity surrounding the first user. In one or more embodiments, when the application selects the second user from the at least one second user or when the application selects the phone number from the plurality of phone numbers associated with the at least one second user, the application transmits one or more of geographic coordinates, a map or address of a location of the first user.

In at least one embodiment of the invention, the one or more features may include a third key obtained from the first user. For example, in at least one embodiment, the third key word is a different key word than the first key word. In one or more embodiments, the application recognizes the third key, and when the application recognizes the third key word, the application executes on the processor to generate an alert that is a notification. In at least one embodiment, based on the notification from the third key word, the application selects a phone number from the plurality of phone numbers associated with the at least one second user, from within the application or from the server, and automatically initiates a voice call to the at least one second user via the processor. Elderly persons or assault victims may utilize the third key to generate an alert, e.g., a notification or call for help if they have fallen and cannot get up, or contact or manipulate their phone to call for help.

In at least one embodiment, the application may automatically select a number from the plurality of phone numbers, or selects the phone number via a command from the first user. In at least one embodiment, the application may automatically initiate the voice call to the the second user without manual interaction or intervention with the computer, for example by the first user. In one or more embodiments, based on the notification, the application may transmit a message to at least one external device via the processor, for example automatically. In at least one embodiment, the at least one external device may include an external computer, processor, network, or any combination thereof.

By way of one or more embodiments, the application may execute on the processor to record video data, audio data, or both video and audio data via the computer. In at least one embodiment, the application may transmit at least a portion of the video data, audio data or both the video data and the audio data to a remote location via the processor. In at least one embodiment, the remote location may include the server, the second user or the external device. In one or more embodiments at least a portion of the video data, audio data or both the video data and the audio data may include data collected a predetermined time interval prior to generating the alert.

According to at least one embodiment, the computer may include a user interface. In one or more embodiments, the alert remains active on the computer until a passcode is entered via the user interface.

In at least one embodiment, the application may execute on the processor to accept a timed alert obtained from and set by the first user. In one or more embodiments, the timed alert is configured between a first location and a second location, or is configured with a time frame, or both. In at least one embodiment, the application may execute on the processor to accept a safe-key from the first user. In one or more embodiment, the time alert is generated when the application detects wherein the first user is at the second location for a predetermined period of time, or when the time frame has expired for a predetermined period of time, or both. In at least one embodiment, the timed alert is not generated when the safe-key is obtained from the first user. This enables a user to set a timed alert before walking through a dangerous area, wherein when arriving at the safe location, the safe-key is emitted by the user to cancel the timed alert that will happen if the safe-key is not received by the system in the predefined time interval.

One or more embodiments may include an accelerometer, gyroscope, or other inertial, triangulation, tactile, proximity or position sensor or any combinations thereof. In at least one embodiment, the application may execute on the processor to collect movement data, tactile data or both, from the motion sensor(s). In one or more embodiments, the application may execute on the processor to extract one or more features from the movement data, the tactile data or both, wherein the one or more features may include at least one thumb print, tap, or shake obtained from the first used on the computer. By way of at least one embodiment, the application may execute on the processor to recognize a gesture from the at least one thumb print, tap, or shake, and, generate an alert upon recognition of the gesture. For example, the user may tap the computer three times to indicate a dangerous event without touching the actual device and without even emitting any sound. In this sense, the indirect or direct physical detection of the gesture is the event that generates an alert. This embodiment is useful in dangerous situations where a perpetrator may become violent if the perpetrator discovers that the user has generated an alert.

### BRIEF DESCRIPTION OF THE DRAWINGS

The above and other aspects, features and advantages of at least one embodiment of the invention will be more apparent from the following more particular description thereof, presented in conjunction with the following drawings, wherein:

FIG. 1 illustrates the overall architecture of the system.

FIG. 2 illustrates an exemplary hardware architecture of one more computers that may be utilized in the system.

FIG. 3 illustrates an exemplary flow chart associated with detecting and asserting an alert.

FIG. 4 illustrates an exemplary flow chart associated with training the system for audio attributes associated with a particular individual that may issue an alert.

FIG. 5 illustrates an exemplary user interface associated with an embodiment of the application.

FIG. 6 illustrates an exemplary chart associated with various sampling rates based on a time of day and location of a particular individual.

FIG. 7 illustrates an exemplary chart associated with a training model to train the system for audio attributes associated with the particular individual that may issue an alert.

### DETAILED DESCRIPTION OF THE INVENTION

The following description is of the best mode presently contemplated for carrying out at least one embodiment of the invention. This description is not to be taken in a limiting sense, but is made merely for the purpose of describing the general principles of the invention. The scope of the invention should be determined with reference to the claims.

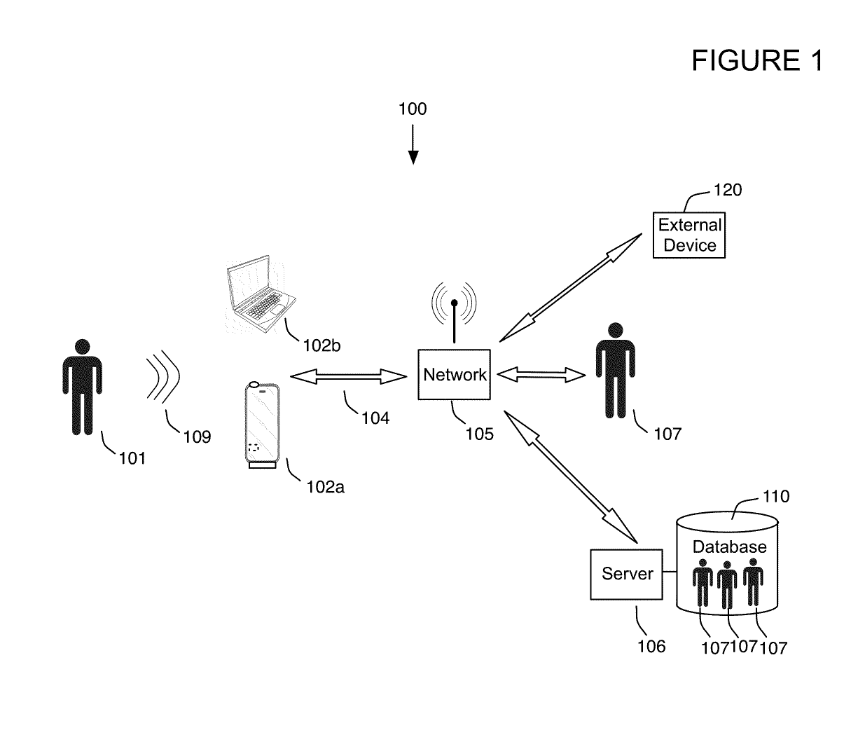

FIG. 1 illustrates the overall architecture of the system, according to one or more embodiments of the invention. As shown in FIG. 1, at least one embodiment provides a personal security system 100 that includes an application that may be executed on a computer, or one or more computers, 102a and 102b. In one or more embodiments, each computing device 102a, 102b may monitor a first user's 101 audio 109, for example continuously, and when a key is detected, send an alert over communications link 104. Computer 102a may represent a mobile phone, while computer 102b may represent any type of computer including, but are not limited to, a tablet computer, laptop computer, desktop computer, server computer, security computer, television, radio, vehicle, car radio, car phone, phone, alarm clock, watch, smart watch, appliance, vehicle, wireless microphone or any other computing device that has or can couple with a microphone whether mobile or stationary.

In at least one embodiment, computer 102a, 102b may communicate with network 105, with a wired or wireless connection, using a data or voice connection or both to send alerts and other data to at least one server 106, for example a security server or police server computer, a second user 107 and/or at least one external device 120, such as another user's mobile device or phone or computer, etc.

Embodiments of the system alert the server 106, second user 107, or external device 120, of a personal or public security or safety issue, or medical issue. The alert may be sent remotely with a local alert to create an alert sound and/or display or without a local alert that would let a perpetrator know that the alert had been generated.

The sampling of audio 109 on computers 102a, 102b may occur continually although is not required to occur continuously. In this disclosure, continually refers to “often or at regular or frequent intervals”, while continuously refers to “uninterrupted in time”. In digital computers, sound sampling generally occurs at discrete points in time, and hence, cannot occur continuously be definition, unlike audio tape recorders. The audio sampling intervals that the sampling occurs at also may not be constant or exact. Hence, in embodiments of the invention, the sampling of audio may be performed at any given sampling rate that enables the detection of a key, phrase or sound. In other embodiments, the sampling rate may be set to detect keys with a particular probability that may be set higher or lower based on available power or potential power consumption or any combination thereof. Embodiments of the invention generally are directed at sampling audio enough of the time to not miss keys, and to provide robust detection of keys to provide safety to the individual.

In one or more embodiments, the computer 102a, 102b may be autonomous and/or may be associated with the first user 101. In at least one embodiment, the computer 102a, 102b may be carried/used by the first user 101. For example, in one or more embodiments, the first user 101 may be moving between two locations, may be located in a dangerous area at a dangerous time, or may be a driver or passenger of a vehicle. In any of these scenarios, embodiments of the invention enable the individual to utter a key that the application on the computer detects and generates an alert so that the user does not have to find, unlock and otherwise manipulate their mobile device or other computer.

In at least one embodiment, the computer 102a, 102b may be a device that is regularly used by the first user 101 for other purposes, such as one or more of emails, text messages, phone calls or other processing tasks, but may also be used as part of the personal security system 101, as will be described below.

In one or more embodiments, the computer 102a, 102b may be a smartphone device, a tablet computer device, a mobile device and the like. In at least one embodiment, the computer 102a, 102b may be another devices located remotely from the first user 101, such as a vehicle computer, so long as the vehicle is equipped with a microphone, or Bluetooth capability to receive sounds from a Bluetooth microphone. Embodiments of the invention may utilize a vehicle's embedded cellular modem or other communications device to send a remote alert. In effect a vehicle having a computer and microphone is another form of a mobile device 102b.

By way of at least one embodiment, the computer 102a, 102b may include communications circuits that allow the computer 102a, 102b to communicate over the communications link 104 to network 105, which could be telephone data or voice network, or to server 106, such as a campus police server or operator. In one or more embodiments, the communications link 104 may be or include a wired or wireless communications link, such as a cellular network, a SMS network, a cellular data network, a computer network, a WiFi network, a wireless computer data network, a wired data network or any other type of communications link. In at least one embodiment, the communications link 104 may allow each computer 102a, 102b to connect to and communicate with one or more of the server 106, at least one second user 107, the at least one external device 120, or any combination thereof, using any known protocols.

In at least one embodiment of the invention, the computer 102a, 102b may include one or more input devices that may provide input to the safety component. For example, in at least one embodiment, the input device may include a microphone that allows the safety component to monitor or for example passively monitor the first user's 101 voice in the background. The computer may include a sensor that may be used to sense movement, proximity, touch or any gesture or physical input other than sound.

In one or more embodiments of the invention, the server 106 may include a selection database 110. In one or more embodiments, the server 106 is located remote to the computer 102a, 102b, and, the application bidirectionally communicates with the server 106. In at least one embodiment, the selection database 110 includes contact information associated with a plurality of second users 107 associated with the first user 101. In at least one embodiment of the invention, the application may include a plurality of phone numbers associated with the plurality of second users 107. In at least one scenario, the list of second users may be traversed to find an available guardian, parent, nearest friend, or security entity to alert or notify via data and/or voice.

According to one or more embodiments, the server 106 may be implemented using one or more computing resources that may include at least one processor, memory, storage, communication circuits, or any combination thereof. In one or more embodiments, the server 106 may be or include cloud-computing resources. In at least one embodiment, the server 106 may include a safety management system that performs the safety functions of the system as will be described further below. In one or more embodiments, the server may include a dispatch system, such that a security issue of the first user 101 may be dispatched to the at least one second user 107, including law enforcement, police or other security agency. In at least one embodiment, the safety management system may be implemented as a plurality of lines of computer code that may be executed on a processor of the server 106, and stored in a memory of the server 106. In one or more embodiments, via the plurality of computer code, the server 106 may interact with the computer 102a, 102b and perform the safety operations as described below in more detail.

In one or more embodiments, the safety management system may be implemented in hardware in which the safety management system is a hardware device or multiple hardware devices, such as processors, microcontrollers, application specific integrated circuits, or any combination thereof. In at least one embodiment, the system 100 may use a client server type architecture wherein each computer 102a, 102b uses a browser application, and wherein the safety management system may have a web server that be software and/or hardware based.

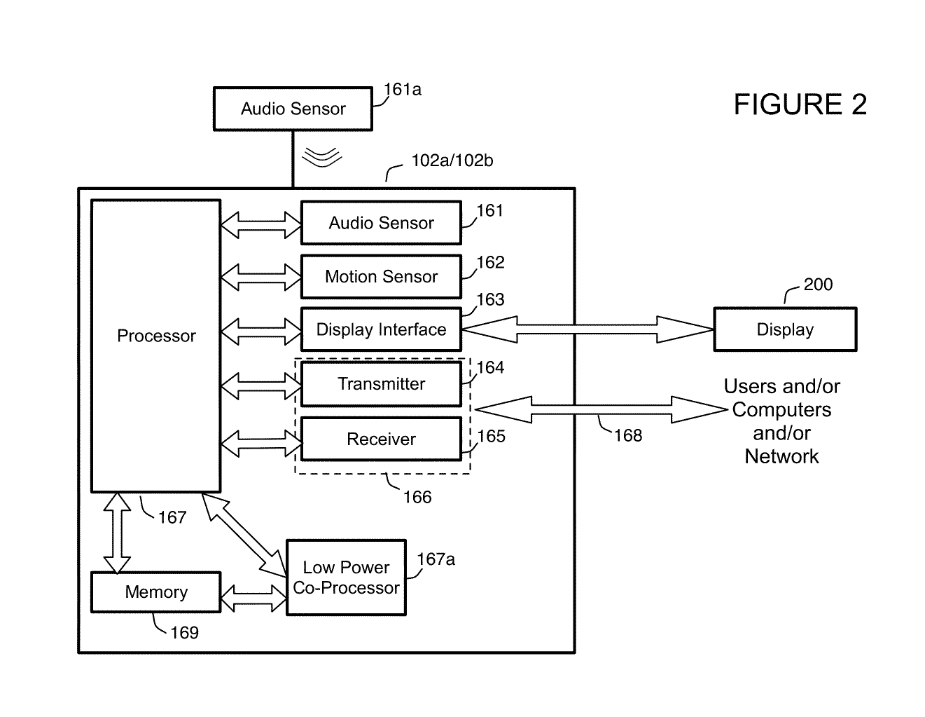

FIG. 2 illustrates an embodiment of one type of hardware architecture that may be utilized in computers 102a, 102b. As shown, computer 102a, 102b may include processor 167, coupled with audio sensor 161 and optional motion sensor 162. In at least one embodiment, processor 167 may also couple with at least a transmitter 164, a receiver 165, (or combined transceiver 166). One or more embodiments may include display interface 163 that couple with a visual display 200 and/or audio speaker or both. Processor 167 may utilize the transmitter 164 and the receiver 165 to bidirectionally communicate with one or more of at least one external display 200, via display interface 163, at least one user other user, at least one other computer and at least one other network. Processor 167 also couples with memory or storage 169, to store an operating system, applications, etc. The storage may include flash memory, read only memory, a hard disk drive or any combination thereof. In at least one embodiment, memory 169 may temporarily or permanently store the operating system, application to be executed by the processor 167, and to temporarily store other data. In at least one embodiment, the safety component may be a standalone application or browser application, the instructions of which may reside in memory, which allows the first user 101 to interact with the system 100. Display interface may also include or couple with a tactile sensor and/or vibration device as is commonly the case with mobile devices.

In one or more embodiments, the processor 167 collects data from audio sensor 161, such as audio data over time and stores the data in a buffer in memory 169. For example, the processor samples audio in the background while the mobile device has power, even when the mobile device is locked. Embodiments may utilize low power co-processor, common in mobile devices to place the main processor 167 in low power mode to conserve power when searching continually for keys. Processor 167 or co-processor 167a then searches the audio data for keys, generally utilizing the lowest power algorithm available depending on the current time, location or audio volume, so as to conserve power and/or provide more accurate key detection with in safe or dangerous locations or times.

In at least one embodiment, when the processor 167 detects a key, an alert is asserted. In one or more embodiments, the key may include any word, phrase or other sound and may be accepted from the individual to initiate the system. In one or more embodiments, the audio patterns of the individual user may be utilized to verify that the key was emitted from that particular user, such as the first user 101, and not another user. In this scenario, the system does not assert an alert signal. Patterns may be stored in memory 169 to compare against in order depending on the algorithm, wherein the patterns may be optimized for minimal processing power utilization during comparison operations.

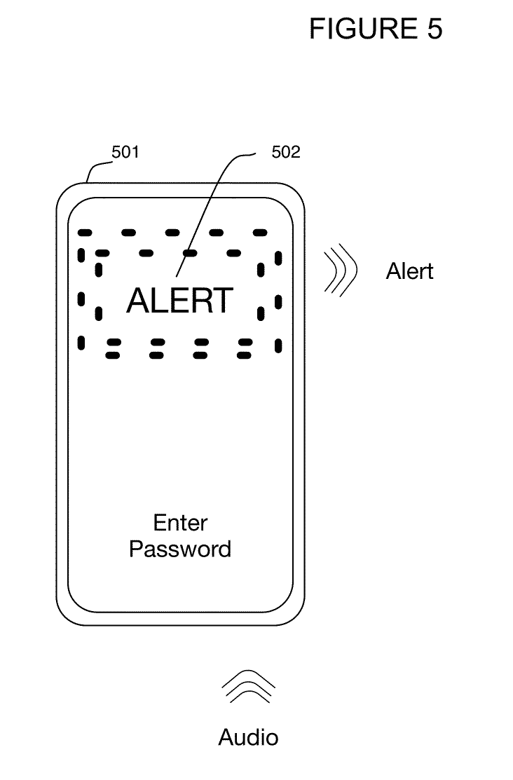

In at least one embodiment, motion sensor 162 may be an accelerometer, gyroscope, or other inertial, triangulation, tactile, proximity or position sensor, such as a global positioning system sensor. For example, in one or more embodiments, the motion sensor may be used to determine if the first user 101 is in motion, such as using various modes of transportation including walking, riding bike, and any other mode of transportation. In at least one embodiment, the computer 102a, 102b may include additional sensors that may be used to trigger when the system 100 goes into an Alert/Listen Mode. In at least one embodiment, the computer 102a, 102b may include a user interface feature, as shown in FIG. 5, including a button press or combination of button presses as is commonly utilized in available display devices. In at least one embodiment, the system 100 may go into the alert/listen mode when the computer 102a, 102b is in particular locations or adjacent particular locations, or the system 100 may go into the alert/listen mode when the computer 102a, 102b has not moved for a predetermined period of time. In one or more embodiments, the computer 102a, 102b may include a clock to determine one or more particular times of day, in some embodiments, embedded within processor 167.

By way of at least one embodiment of the invention, the application executes continually on the processor 167 to collect data. In at least one embodiment, the application executes when the computer 102a, 102b is on, when the computer 102a, 102b is locked and when the computer 102a, 102b is unlocked, or asleep or in any other mode while power is available to processor 167 or 167a. The application may execute without any indication on the screen 200, or display interface 163, of the computer 102a, 102b, such as a mobile device, to listen as much as possible or to listen at predefined intervals or in any other manner.

By way of at least one embodiment, the computer 102a, 102b may include or may be directly or indirectly coupled with the at least one audio sensor 161, 161a respectively. In some embodiments, a remote microphone or wireless microphone may be utilized to detect audio data as shown with hardwire and wireless signals between audio sensor 161a and computer 102a, 102b in FIG. 2. In at least one embodiment, the computer 102a, 102b may include a security system computer with a remote audio sensor that captures the audio data.

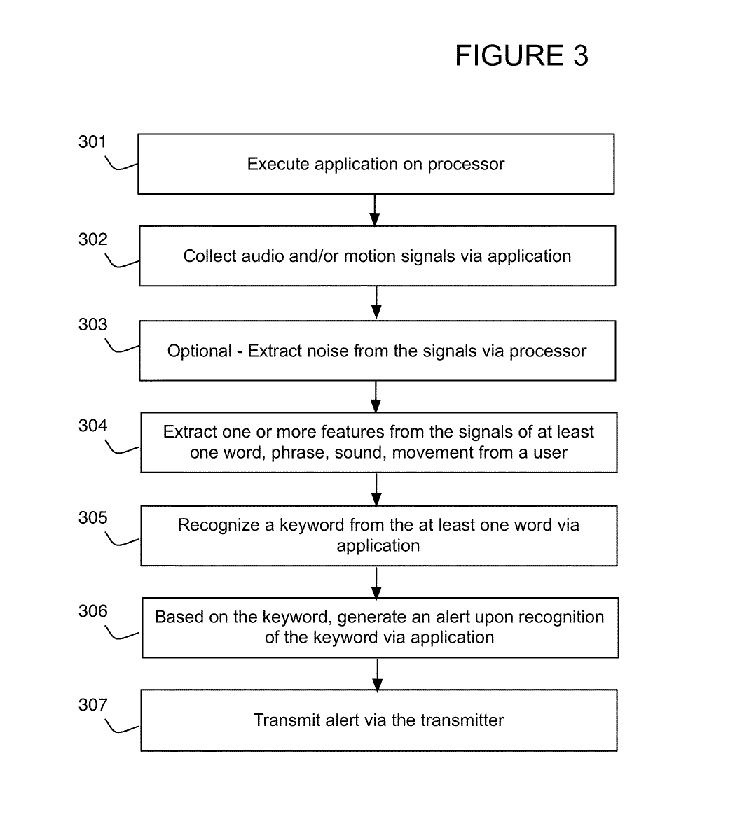

FIG. 3 illustrates an exemplary flow chart associated with detecting and asserting an alert, according to one or more embodiments of the invention. As shown in FIG. 3, in at least one embodiment, the application may execute on the processor 167 at 301 to collect the data, such as the audio data, and optionally motion data, via the application, at 302. The audio data is stored in memory 169 as shown in FIG. 2. In one or more embodiments, the application may execute on the processor 167 to optionally extract noise from the data via the processor 167, at 303. In at least one embodiment, the application may execute on the processor 167 to extract one or more features from the data at 304, wherein the features may include or characteristics associated with at least one word, phrase or sound, or movement obtained from the first user 101. The characteristics may include frequency ranges and time durations for example or any other known measurements that enable key pattern matching. In one or more embodiments, the features enable low power or efficient pattern matching to conserve battery power. In one or more embodiments, the application may execute on the processor 167 or co-processor 167a to recognize a key from the audio data to detect at least one word, phrase or sound at 305, and generate an alert upon recognition of the key via the application at 306, (embodiments may also utilize the motion sensor and recognize a motion based key, e.g., by matching a series of taps or gestures). Any type of audio recognition algorithm may be utilized including power efficient algorithms such as taught in U.S. Pat. No. 6,463,413, filed Apr. 20, 199 to Applebaum, which is herein incorporated herein by reference. In one or more embodiments, the processor may assert an alert and locally provide the alert through audio or visual or tactile elements, or transmit the alert via the transmitter 164, at 307, to a remote server, such as server 106, or a second user 107. One or more embodiments may provide the alert locally as well as remotely.

In one or more embodiments, the data utilized in determining an event worthy of an alert may include motion data, wherein the features include at least one movement associated with the first user 101. In at least one embodiments, the application collects the motion data via the at least one motion sensor 162. In one or more embodiments, the one or more features may include a combination of a second key obtained from the first user 101 and the at least one movement associated with the first user 101, wherein the combination occurs within a predetermined time window. In at least one embodiment of the invention, the application may execute on the processor 167 to filter the noise from the data before the application extracts the one or more features from the data. In one or more embodiments, the key may include no audio data and only gestures of movement data.

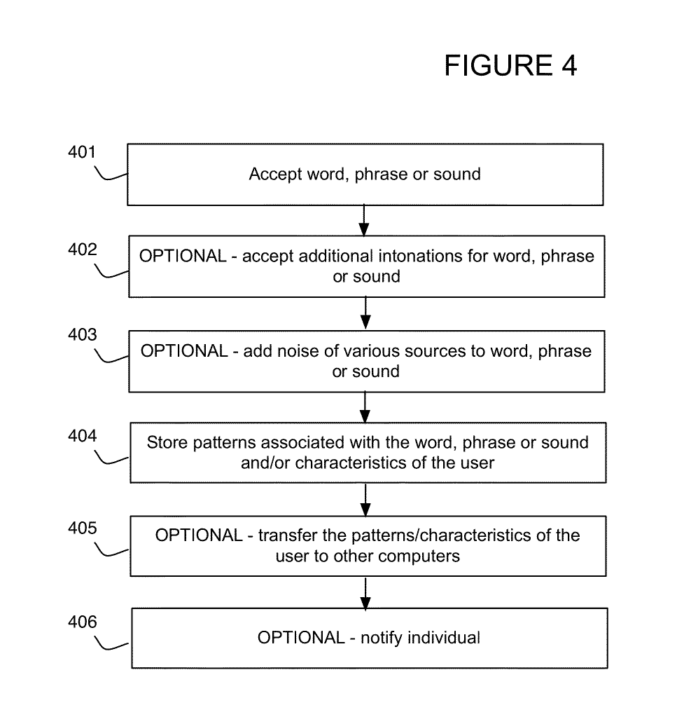

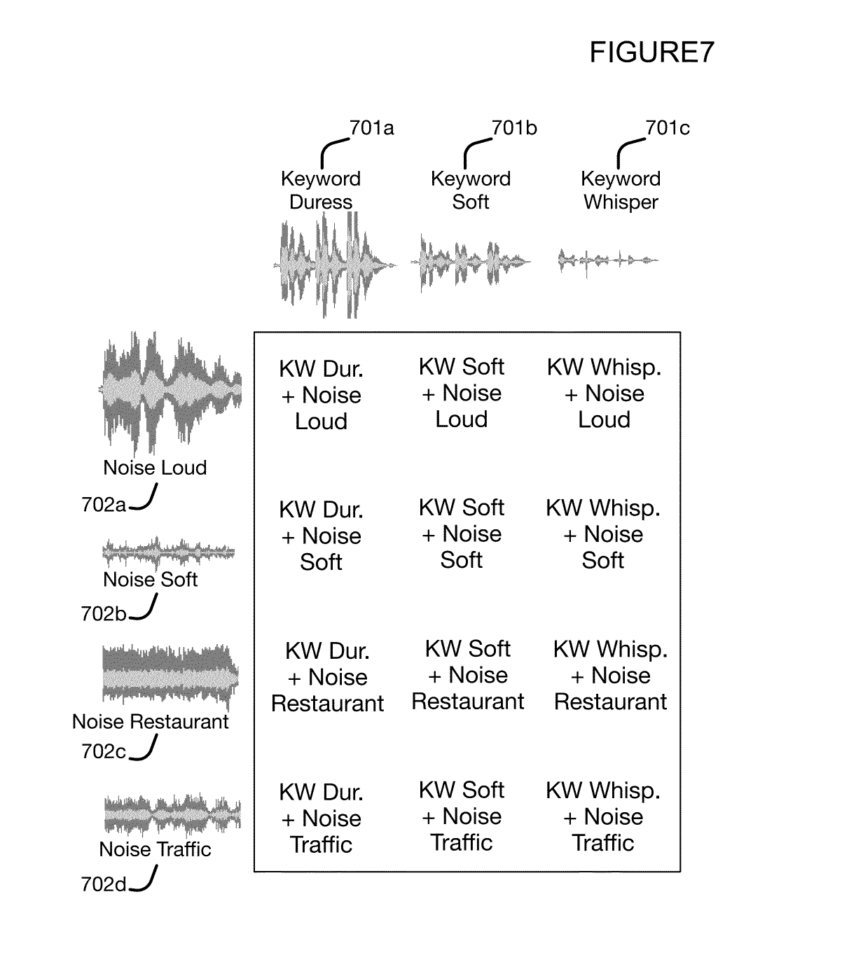

FIG. 4 illustrates an exemplary flow chart associated with training the system for audio attributes associated with a particular individual that may issue an alert, according to one or more embodiments of the invention. In at least one embodiment, as shown in FIG. 4, the application may accept the at least one word, phrase or sound, at 401, in a plurality of intonations from the first user 101. In one or more embodiments, the application may accept additional intonations for the word, phrase or sound at 402, and/or may add noise of various sources to the word, phrase or sound, at 403, and as will be described further regarding FIG. 7. In at least one embodiment, the application may store patterns associated with the word, phrase or sound, and/or characteristics of the first user 101, at 404. In one or more embodiments, the application may transfer the patterns and characteristics of the first user 101 to the server 106, one or more other computers, users, networks, or any combination thereof, at 405. In this way, the user may utilize the same training data for multiple devices, and transfer the patterns to each or all of the users devices to automatically train the other devices to recognize the keys for the particular user. In at least one embodiment, the application may notify the individual of the completion of training at 406.

In at least one embodiment, the server 106 may combine the at least one word, phrase or sound with noise, as shown in step 403 for example, to generate training data. In one or more embodiments, the server 106 may receive the various keys and intonations thereof, generate the training data for example by including various known noise sources, and transmit the training data to the computer 102a, 102b. The trained model is personalized to the first user 101 and enables lower power key searching on the user's computer 102a, 102b. In at least one embodiment, the training data may include sample data, wherein each of the sample data include an algorithmically defined pattern and code associated with the at least one word, phrase or sound, as will be discussed further below regarding FIG. 7. In one or more embodiments, the trained model may be generated and personalized by the first user 101 within the application via the processor 167, and/or via the server 106, which is then downloaded onto the computer 102a, 102b. By way of one or more embodiments, the application may include a commercially available or custom voice recognition algorithm. In at least one embodiment, the application executes on the processor 167 to modulate waveforms of the data and input the waveforms to the voice recognition algorithm.

In at least one embodiment, the step of recognizing the key from the at least one word, phrase or sound includes a comparison of the at least one word, phrase or sound to the trained model to determine whether the at least one word, phrase or sound correlates with the trained model. In one or more embodiments, the trained model may be generated and personalized by the first user 101 within the application via the processor 167. In at least one embodiment, the trained model may be generated and personalized by the first user 101 via the server, and may be downloaded onto the computer. In at least one embodiment of the invention, when the at least one word, phrase or sound does not correlate with the trained model, the application, via the processor 167, continues to collect the data. In at least one embodiment, when the at least one word, phrase or sound does correlate with the trained model, the application generates the alert, and the processor 167 transmits the alert via the transmitter 164.

According to one or more embodiments of the invention, the data collected may include an algorithmically defined pattern and code, wherein the application determines whether the at least one word, phrase or sound correlates with the trained model by comparing the pattern and code of the data to the pattern and code of the sample data.

In one or more embodiments, when the application generates the alert, the application determines whether a data service is available via the computer 102a, 102b, whether a voice service is available via the computer 102a, 102b, or both. In at least one embodiment, when the data service is available, the application transmits the alert to the server 106 via the processor 167 and the transmitter 164, the server 106 receives the alert. In one or more embodiments, when the server 106 receives the alert, the server 106 selects a second user from the at least one second user 107 associated with the first user 101, and transmits a notification to the second user 107. For example, in at least one embodiment, the second user 107 may include a guardian, a parent, other relative if the parent is not nearby, security personnel, law enforcement, government officials, school campus personnel, etc. In one or more embodiments, when the voice service is available, for example when the application determines wherein the data service is unavailable, the application selects a phone number from the plurality of phone numbers associated with the at least one second user 107 and initiates a voice call to the at least one second user 107.

By way of at least one embodiment, the server 106 may select the second user 107 from the at least one second user, and/or the application may select the phone number from the plurality of phone numbers associated with the at least one second user 107, based on which of the at least one second user 107 is deemed most likely to be able to respond to the notification. In one or more embodiments, which of the at least one second user 107 is deemed most likely to be able to respond to the notification is based on one or more parameters selected from a location of the first user 101, a time of day, a location of the at least one second user 107, and, a presence or absence of the at least one second user 107 located within a predetermined vicinity surrounding the first user 101. In one or more embodiments, when the application selects the second user from the at least one second user 107 or when the application selects the phone number from the plurality of phone numbers associated with the at least one second user 107, the application transmits one or more of geographic coordinates, a map or address of a location of the first user 101.

In at least one embodiment of the invention, the one or more features may include a third key obtained from the first user 101. For example, in at least one embodiment, the third key word is a different key word than the first key word. In one or more embodiments, the application recognizes the third key, and when the application recognizes the third key word, the application executes on the processor 167 to generate a notification. In at least one embodiment, based on the notification from the third key word, the application selects a phone number from the plurality of phone numbers associated with the at least one second user 107, from within the application or from the server, and automatically initiates a voice call to the at least one second user 107 via the processor 167.

In at least one embodiment, the application may automatically select a number from the plurality of phone numbers, or selects the phone number via a command from the first user 101. In at least one embodiment, the application may automatically initiate the voice call to the at least one second user 107 without manual interaction or intervention with the computer 102a, 102b, for example without manual interaction or intervention by the first user 101. For example, the first user 101 may be an elderly user in need of assistance during an emergency, wherein such a user in incapable of reaching the computer 102a, 102b to initiate the voice call. In one or more embodiments, based on the notification, the application may transmit a message to the at least one external device 120 via the processor 167, for example automatically or on command. In at least one embodiment, the at least one external device 129 may include an external computer, processor, network, or any combination thereof.

FIG. 5 illustrates an exemplary user interface associated with an embodiment of the application, according to one or more embodiments of the invention. As shown in FIG. 5, in at least one embodiment, the computer 102a, 102b may include a mobile computer, tablet or any other computer with a housing. In one or more embodiments, the computer 102a, 102b may include a user interface 501, on the display interface 163 for example, to display and communicate data to the first user 101. In one or more embodiments, the user interface 501 may display the alert as an alert message 502, shown with flashing pixels, and “Alert” representing an audio alert and/or remote alert, wherein the alert 502 remains active on the user interface 501, until a passcode is entered via the user interface 501. Other embodiments may be set to send only a remote alert so as to not notify any potential perpetrator of the alert. In one or more embodiments, the user interface 501 may ask the first user 101 to enter a password, wherein the password may include one or more of numbers and letters. In at least one embodiment, the passcode may be generated and personalized by the first user 101. In one or more embodiments, the passcode may be generated via the application executed on the processor 167 and the user interface 501 directly, and/or via the server 106, which is then downloaded onto the computer 102a, 102b.

In at least one embodiment, the application may execute on the processor 167 to accept a timed alert obtained from and set by the first user 101. In at least one embodiment, the timed alert may be obtained and set by the first user 101 via the user interface 501. In one or more embodiments, the timed alert is configured between a first location and a second location, or is configured with a time frame, or both. In at least one embodiment, the application may execute on the processor 167 to accept a safe-key from the first user 101. In one or more embodiment, the time alert is generated when the application detects wherein the first user 101 is at the second location for a predetermined period of time, or when the time frame has expired for a predetermined period of time, or both. In at least one embodiment, the timed alert is not generated when the safe-key is obtained from the first user 101.

One or more embodiments may include an accelerometer, gyroscope, or other inertial, triangulation, tactile, proximity or position sensor or any combination thereof, for example as shown as the motion sensor. In at least one embodiment, the application may execute on the processor 167 or co-processor 167a to collect movement data, tactile data or both, from the motion sensor. In one or more embodiments, the application may execute on the processor 167 or co-processor 167a to extract one or more features from the movement data, the tactile data or both. In one or more embodiments, the one or more features may include at least one thumb print, tap, or shake obtained from the first user 101 on the computer 102a, 102b. By way of at least one embodiment, the application may execute on the processor to recognize a gesture from the at least one thumb print, tap, or shake, and, generate an alert upon recognition of the gesture.

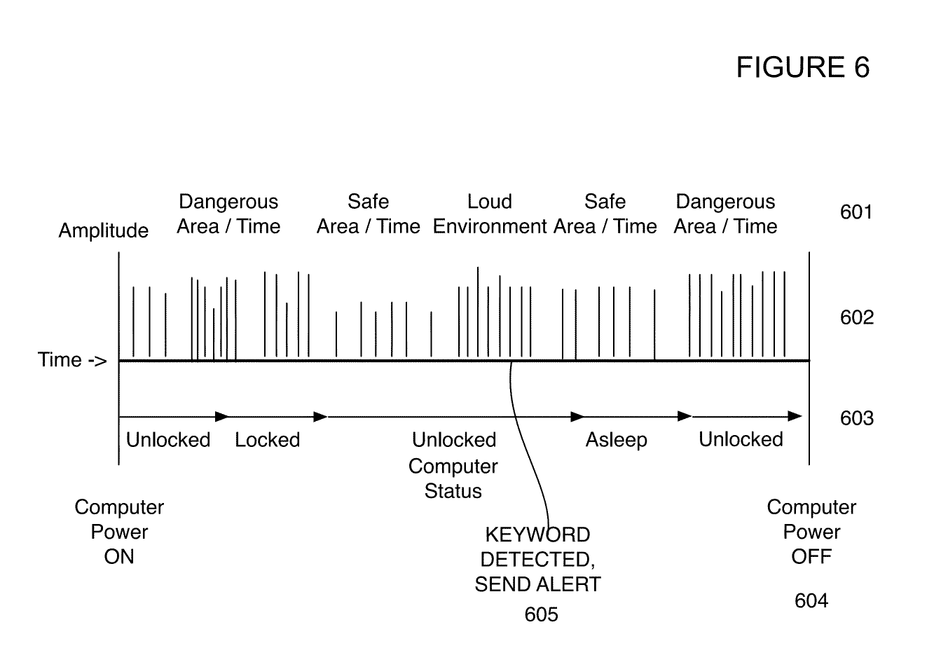

FIG. 6 illustrates an exemplary chart associated with various sampling rates based on a time of day and location of a particular individual. According to at least one embodiment, the data, such as the audio data, may be collected at predefined intervals or substantially continually. In at least one embodiment, the predefined intervals may include a fixed sampling rate or one or more sampling rates. The sampling may have uniform or non-uniform time intervals between samples. As shown at 601, the type of environment, e.g., a dangerous environment or time, safe environment or time is utilized to change the sampling rate of the audio to conserve power, and/or to optimize the quality of the detection based on noise or environmental volume. The amplitude and sampling rates are shown in an exemplary manner at 602. As shown, the sampling occurs when the computer is ON, and until the computer is OFF as shown at 604. In addition, the sampling occurs when the computer is locked, unlocked, asleep or in any other mode at 603. The sampling of motion or movement data may also be altered based on parameters 601. When a key is detected at 605, an alert is displayed either locally, or remotely or both.

By way of one or more embodiments, processor 167 or co-processor 167a may also record video data along with audio data, and/or motion data. In at least one embodiment, the application may transmit at least a portion of the video data, audio data or both the video data and the audio data to a remote location. In at least one embodiment, the remote location may include the server 106, the at least one second user 107 or the external device 120. In one or more embodiments the portion of the video data, audio data or both the video data and the audio data may include data collected a predetermined time interval prior to generating the alert so that context of the event may be understood by the receiver of the information, and/or forensic use later. The location of the computer may also be sent in the alert as detected by the motion sensor or as triangulated by the receiver or determined in any other manner.

FIG. 7 illustrates an exemplary chart associated with a training model to train the system for audio attributes associated with the particular individual that may issue an alert. As shown, the user may speak a key, such as a word, phrase or sound in different speeds or volumes as might be encountered during a event that warrants an alert. As shown, the key is spoken under duress, e.g., by shouting the key at 701a. The key is also obtained by the system as spoken in a soft voice at 701b. The system further collects the audio data at whisper level at 701c. In order to train computer 102a to detect the key under various background sounds, loud noise, soft noise, restaurant noise, and traffic noise or frequency patterns and duration related thereto is combined with the key at various intonations to provide patterns for computer 102a, 102b to utilize to detect the key in an efficient and robust manner. In one or more embodiments, step 305 as shown in FIG. 3, compares the patterns to the sound samples to detect the key.

Vehicle Related Scenarios

One or more embodiments of the invention may be utilized by a driver or passenger of a vehicle. The user may be in the vehicle or entering or leaving the vehicle for example to give more security for drivers and riders of ride sharing vehicles. It will be appreciated, however, that the system and method has greater utility since it may be implemented using other types of computing devices instead of or in addition to a smartphone. Furthermore, the system may be utilized whenever the user is in motion between two locations, such as by various transportations means including a vehicle, a bicycle or walking.

According to one or more embodiments, the system and method as described may passively monitor a person's communications during times of potential risk and allow the first user 101 to notify law enforcement or another individual or organization, such as the at least one second user 107, of a personal or public safety issue without alerting the perpetrator. Thus, in at least one embodiment, for example, the system provides increased security to people that are the victim of crimes while driving in their vehicles (although the system may be used by a user who is not within a vehicle). Unlike other safety applications, the system automatically (without continued user input) puts the computing device, such as a mobile phone, into an alert/listen mode allowing the user to quickly and easily connect with a third party, such as the at least one second user 107, the server 106 and/or the at least one external device 120, through data communication or a voice call, that may help ensure the safety of the first user 101. Embodiments of the system may be useful in protecting and providing an extra level of security for drivers of all kinds, including taxi and limo and ride share services and is also provides an extra level of security for any driver for any reason, such as car jacking.

In the use case for any driver, an initialization process of the application, otherwise known as the safety component may be performed at some point by the user. During the initialization process of the safety component, the safety component may be started (or already running) and the user may be prompted to record a word, phrase or sound (the “Voice Sound”) that the user would say and the computing device 102a, 102b (using the microphone and the safety component) would recognize as an indication of an emergency or problem. Alternatively (or additionally), the safety component may also display a user interface feature, such as a button, that the user could touch to initiate an emergency contact in lieu of or in addition to the Voice Sound. The voice sound or the depressing of the user interface feature may be known as an “Emergency Contact Initiation”.

Once the user gets into a vehicle to drive, the user may open up the safety component and start it (unless it is already started.) Alternatively, the safety component may be already active, such as running in the background or may be activated automatically whenever the computing device 102a, 102b makes a connection to the user's car blue tooth system. The automatic activation of the safety component may be a way to ensure that the safety component is active when the user is in the vehicle.

When the safety component is active and the user is in the vehicle, the safety component (and hence the computing device 102a, 102b) may enter an alert/listen mode (“Alert/Listen Mode”) in which the safety component is passively monitoring the user for the “Emergency Contact Initiation” and take the appropriate action as described below in more detail. In some embodiments, the Alert/Listen Mode may be responsive to a safe word, a panic word or no response during a time period. In these embodiments, the utterance of the panic word or no response from the user while in the Alert/Listen Mode during the time period may cause the safety component to contact a third party helper as described above. In these embodiments, the utterance of the safe word would cause the safety component to exit the alert/list mode.

The safety component may enter the alert/listen mode when it is either told by the user that the user is driving or when the computing device 102a, 102b makes a blue tooth connection with the vehicle. The safety component may stay in that Alert/Listen Mode for the entirety of the time while the user is driving until the user either closes the safety component or the blue tooth connection between the car and the user is broken. Alternatively, to save battery life of the computing device 102a, 102b, the computing device 102a, 102b may go into the Alert/Listen Mode only each time the vehicle slows to a certain speed or comes to a stop or brakes or swerves in a certain way, which could be determined using the sensor of the computing device, such as an accelerometer, or for example as detected by motion sensor 102, e.g., an accelerometer or GPS component.

When the safety component is in the Alert/Listen Mode and the user makes the Emergency Contact Initiation, the safety component (using components of the computing device 102a, 102b) contact, such as either by texting or calling, the safety management component or server 106 or user 107 indicating that the user is having an emergency. In addition, when the user makes an Emergency Contact Initiation, the safety component (using components of the computing device 102a, 102b) may obtain a position of the user (such as by using the GPS sensor) and may forward that position information to the safety management component 106 that may in turn contact a third party helper 107 or user of device 120. The safety component may also obtain the position information at regular and repeated intervals (and send that position information to the safety management component 106) until the emergency condition is resolved so that the user could be readily tracked by the third party helper. The third party helper may be a friend or family member, a call center, an emergency service of some nature (like a house alarm company that would call the house if an alarm went off), 911 or anyone that might be designated during configuration of the system. In some embodiments, the safety component may directly contact 911 if an Emergency Contact Initiation occurs. However, it is more likely that it would connect to some sort of call center first so that a lot of false alarms aren't reported to 911.

At this point, the Third Party Helper may contact the user to make sure everything is ok and, if not, could contact a higher level of emergency service if necessary. In addition, for security purposes, the system may allow the Third Party Helper to speak with the user or alternatively, just listen to help determine, based on what the Third Party Helper hears, whether there is an emergency and by doing this, the perpetrator would not be alerted that an emergency has been called in. In some embodiments, the system may have different service levels being made available to the consumer. For example, if the driver says the panic word, the safety component (using components of the computing device 102a, 102b) may immediately call a friend's or family member's phone number (and maybe even let that friend or family member know that the call was initiated because the panic word was spoken). If that friend does not answer the call, the safety component may call another number and so on. A higher level of service would be to have the safety component contact a call center or emergency service in the event the Emergency Contact Initiation occurs.

For consumer purposes, the user could also geo-fence the user's home location (or other specified location such as the user's work location or school), which could cause the safety component to go into the Alert/Listen Mode each time the consumer arrives home. Thus, each time the user arrived home, a timed count down would occur and the user would either say a safe word in which case all was good or say the Panic word or say nothing, in which case there is a problem. Similarly, if the user input the location to which the user was heading, the system could go into the Alert/Listen Mode with a timed count down when the user reached the location inputted.

In addition to the example above in which a driver of a vehicle uses the system, the system may be used for law enforcement vehicles or military. In addition, the system may be used any time that a user is in movement (whether by vehicle, on a bicycle, on a motorcycle, walking) and may enter the same alert/listen mode as described above.

Taxi/Limo/Ride Share Driver Use Case

In this use case, the driver may record two or more Voice Sounds including a “Safe Word” that indicates that everything is ok for the user and a “Panic Word” that indicates that something is wrong for the user. As described above, the system may alternatively use a user interface action for the above, such as a Safe button or a Panic button that may be pressed by the user.

When the driver receives a notification that he/she has a passenger to pick up including the pick-up location for that passenger, the safety component may navigate the driver to the “Pick-Up Location”. For this use case, the safety component may be linked to or part of an overall transportation system so that the safety component can then perform the navigation using components of the computing device 102a, 102b. The safety component may obtain regular positions of the driver's location and the system would thereby know when the driver arrives at the Pick-Up Location.

Once the driver arrives at the Pick-Up Location, the safety component may go into the Alert/Listen Mode and could also go into a timed count down (e.g., 5 minutes). If during the timed count down, the driver says the Safe Word, then the system knows that all is ok (probably that the passenger that the driver was supposed to pick up is the passenger that go into the vehicle). If, on the other hand, the driver says the Panic during the timed count down, then this would be indicative of something being wrong (a potential emergency situation), in which case the phone would instantaneously perform the process of contacting the third party helper as described above. If the driver does not say the safe word before the count-down expired (or the car started moving again even before the count-down expired), either because something bad has happened to the driver or because the driver just forgot to say it, the safety component would be made to either connect directly with a call center, a network or an emergency service which would then speak with the driver. The driver would always have the ability to extend the time of the count-down (for example, if the passenger doesn't get into the vehicle right away).

For purposes of a taxi/limo/ride share driver, the safety component could also either always be in the Alert Listen Mode or go into that mode each time the vehicle comes to a stop or slows just like in the first example described above. The main difference being that in that situation, the phone is just listening for the Panic Word. It doesn't have the ability to know that silence means an emergency or that a countdown has been initiated.

In addition to the examples described above, another implementation of the system may be a personal safety system for a child, such as a daughter, son, wife, etc. that has the same Emergency Contact Initiation process and procedure, but the contact person would be a person, such as a parent, who would be called or texted in the case of an emergency (assuming that was the first thing we do when there is an Emergency Contact Initiation. During the Emergency Contact Initiation, the device may allow the contact person monitor the location of the device and the person. However, once the Emergency Contact Initiation is completed, the contact person would not longer have the ability to monitor the location of the device or person.

The foregoing description, for purpose of explanation, has been described with reference to specific embodiments. However, the illustrative discussions above are not intended to be exhaustive or to limit the disclosure to the precise forms disclosed. Many modifications and variations are possible in view of the above teachings. The embodiments were chosen and described in order to best explain the principles of the disclosure and its practical applications, to thereby enable others skilled in the art to best utilize the disclosure and various embodiments with various modifications as are suited to the particular use contemplated.

The system and method disclosed herein may be implemented via one or more components, systems, servers, appliances, other subcomponents, or distributed between such elements. When implemented as a system, such systems may include an/or involve, inter alia, components such as software modules, general-purpose CPU, RAM, etc. found in general-purpose computers, In implementations where the innovations reside on a server, such a server may include or involve components such as CPU, RAM, etc., such as those found in general-purpose computers.

Additionally, the system and method herein may be achieved via implementations with disparate or entirely different software, hardware and/or firmware components, beyond that set forth above. With regard to such other components (e.g., software, processing components, etc.) and/or computer-readable media associated with or embodying the present inventions, for example, aspects of the innovations herein may be implemented consistent with numerous general purpose or special purpose computing systems or configurations. Various exemplary computing systems, environments, and/or configurations that may be suitable for use with the innovations herein may include, but are not limited to: software or other components within or embodied on personal computers, servers or server computing devices such as routing/connectivity components, hand-held or laptop devices, multiprocessor systems, microprocessor-based systems, set top boxes, consumer electronic devices, network PCs, other existing computer platforms, distributed computing environments that include one or more of the above systems or devices, etc.

In some instances, aspects of the system and method may be achieved via or performed by logic and/or logic instructions including program modules, executed in association with such components or circuitry, for example. In general, program modules may include routines, programs, objects, components, data structures, etc. that perform particular tasks or implement particular instructions herein. The inventions may also be practiced in the context of distributed software, computer, or circuit settings where circuitry is connected via communication buses, circuitry or links. In distributed settings, control/instructions may occur from both local and remote computer storage media including memory storage devices.

The software, circuitry and components herein may also include and/or utilize one or more type of computer readable media. Computer readable media can be any available media that is resident on, associable with, or can be accessed by such circuits and/or computing components. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic tape, magnetic disk storage or other magnetic storage devices, or any other medium which can be used to store the desired information and can accessed by computing component. Communication media may comprise computer readable instructions, data structures, program modules and/or other components. Further, communication media may include wired media such as a wired network or direct-wired connection, however no media of any such type herein includes transitory media. Combinations of the any of the above are also included within the scope of computer readable media.

In the present description, the terms component, module, device, etc. may refer to any type of logical or functional software elements, circuits, blocks and/or processes that may be implemented in a variety of ways. For example, the functions of various circuits and/or blocks can be combined with one another into any other number of modules. Each module may even be implemented as a software program stored on a tangible memory (e.g., random access memory, read only memory, CD-ROM memory, hard disk drive, etc.) to be read by a central processing unit to implement the functions of the innovations herein. Or, the modules can comprise programming instructions transmitted to a general purpose computer or to processing/graphics hardware via a transmission carrier wave. Also, the modules can be implemented as hardware logic circuitry implementing the functions encompassed by the innovations herein. Finally, the modules can be implemented using special purpose instructions (SIMD instructions), field programmable logic arrays or any mix thereof which provides the desired level performance and cost.

As disclosed herein, features consistent with the disclosure may be implemented via computer-hardware, software and/or firmware. For example, the systems and methods disclosed herein may be embodied in various forms including, for example, a data processor, such as a computer that also includes a database, digital electronic circuitry, firmware, software, or in combinations of them. Further, while some of the disclosed implementations describe specific hardware components, systems and methods consistent with the innovations herein may be implemented with any combination of hardware, software and/or firmware. Moreover, the above-noted features and other aspects and principles of the innovations herein may be implemented in various environments. Such environments and related applications may be specially constructed for performing the various routines, processes and/or operations according to the invention or they may include a general-purpose computer or computing platform selectively activated or reconfigured by code to provide the necessary functionality. The processes disclosed herein are not inherently related to any particular computer, network, architecture, environment, or other apparatus, and may be implemented by a suitable combination of hardware, software, and/or firmware. For example, various general-purpose machines may be used with programs written in accordance with teachings of the invention, or it may be more convenient to construct a specialized apparatus or system to perform the required methods and techniques.

Aspects of the method and system described herein, such as the logic, may also be implemented as functionality programmed into any of a variety of circuitry, including programmable logic devices (“PLDs”), such as field programmable gate arrays (“FPGAs”), programmable array logic (“PAL”) devices, electrically programmable logic and memory devices and standard cell-based devices, as well as application specific integrated circuits. Some other possibilities for implementing aspects include: memory devices, microcontrollers with memory (such as EEPROM), embedded microprocessors, firmware, software, etc. Furthermore, aspects may be embodied in microprocessors having software-based circuit emulation, discrete logic (sequential and combinatorial), custom devices, fuzzy (neural) logic, quantum devices, and hybrids of any of the above device types. The underlying device technologies may be provided in a variety of component types, e.g., metal-oxide semiconductor field-effect transistor (“MOSFET”) technologies like complementary metal-oxide semiconductor (“CMOS”), bipolar technologies like emitter-coupled logic (“ECL”), polymer technologies (e.g., silicon-conjugated polymer and metal-conjugated polymer-metal structures), mixed analog and digital, and so on.

It should also be noted that the various logic and/or functions disclosed herein may be enabled using any number of combinations of hardware, firmware, and/or as data and/or instructions embodied in various machine-readable or computer-readable media, in terms of their behavioral, register transfer, logic component, and/or other characteristics. Computer-readable media in which such formatted data and/or instructions may be embodied include, but are not limited to, non-volatile storage media in various forms (e.g., optical, magnetic or semiconductor storage media) though again does not include transitory media. Unless the context clearly requires otherwise, throughout the description, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

It will be apparent to those skilled in the art that numerous modifications and variations of the described examples and embodiments are possible in light of the above teaching. The disclosed examples and embodiments are presented for purposes of illustration only. Other alternate embodiments may include some or all of the features disclosed herein. Therefore, it is the intent to cover all such modifications and alternate embodiments as may come within the true scope of this invention.

What is claimed is:

1. A personal security system comprising:
an application configured to execute on a computer, wherein said computer comprises
audio sensor;
a transmitter;
a receiver;
a processor coupled with said audio sensor, said transmitter and said receiver;
wherein said application executes continually on said processor to
collect data, wherein said data comprise audio data obtained from said audio sensor,
wherein said audio data are collected at predefined intervals and wherein said predefined intervals comprise a fixed sampling rate or one or more sampling rates;
extract one or more features from said data, wherein said one or more features comprise at least one word, phrase or sound obtained from a first user;
recognize a key from said at least one word, phrase or sound;
generate an alert upon recognition of said key;
wherein said processor is configured to both locally provide the alert and transmit said alert via said transmitter; and
wherein said processor configured to locally provide the alert comprises wherein said processor asserts the alert locally on said computer to draw attention to the first user through one or more of audio, visual and tactile elements, wherein said alert comprises one or more of a flashing light, a vibration and an alarm sound.

2. The personal security system of claim 1, wherein said computer is a mobile device associated with said first user and wherein said application executes when said computer is locked and when said computer is unlocked.

3. (canceled)

4. The personal security system of claim 1, wherein said application is further configured to alter said fixed sampling rate or said one or more sampling rates to use less or more power based on one or more of a time of day or location of said first user.

5. The personal security system of claim 1, wherein said audio sensor comprises a remote or wireless microphone that is remote to said computer and that transmits said audio data to said computer.

6. The personal security system of claim 1, wherein said computer is a security system computer comprising a remote audio sensor that captures said audio data.

7. The personal security system of claim 1, further comprising a low power co-processor coupled with said processor, and wherein said application executes on said low power co-processor and wherein when said application executes on said low power co-processor, said processor is powered off, or is switched into low power mode or is switched into sleep mode.

8. The personal security system of claim 1, wherein said application executes on said processor to collect said data and generate said alert upon recognition of said key without manual interaction with said computer by said first user.

9. The personal security system of claim 1, wherein said data further comprises motion data, and wherein said one or more features further comprise at least one movement associated with said first user.

10. The personal security system of claim 9, wherein said computer further comprises a motion sensor coupled with said processor, and wherein said application further collects said motion data via said motion sensor.

11. The personal security system of claim 9, wherein said one or more features further comprise a combination of a second key obtained from said first user and said at least one movement associated with said first user, wherein said combination occurs within a predetermined time window.

12. The personal security system of claim 1, wherein said application executes on said processor to filter noise from said data before said application extracts said one or more features from said data.

13. The personal security system of claim 1, wherein said application is further configured to accept said at least one word, phrase or sound in a plurality of intonations from said first user.

14. The personal security system of claim 13, wherein said system compares said at least one word, phrase or sound in a plurality of intonations against characteristics of the first user to minimize false positives with other users.

15. The personal security system of claim 14, further comprising a server that combines said at least one word, phrase or sound with noise to generate training data.

16. The personal security system of claim 15, wherein said server transmits said training data to said computer to generate a trained model that is personalized to said first user.

17. The personal security system of claim 16, wherein said training data comprises sample data, wherein each of said sample data comprise an algorithmically defined pattern and code associated with said at least one word, phrase or sound in a plurality of intonations.

18. The personal security system of claim 17, wherein said recognize said key from said at least one word, phrase or sound comprises a comparison of said at least one word, phrase or sound to said trained model to determine whether said at least one word, phrase or sound correlates with said trained model,
wherein when said at least one word, phrase or sound does not correlate with said trained model, said application continues to collect said data, and,
wherein when said at least one word, phrase or sound does correlate with said trained model, said application generates said alert, and said processor transmits said alert via said transmitter.

19. The personal security system of claim 1, further comprising a server comprising a selection database,
wherein said selection database comprises contact information associated with a plurality of second users, wherein at least one second user of said plurality of second users is associated with said first user,
wherein said server is located remote to said computer, and,
wherein said application bidirectionally communicates with said server.

20. The personal security system of claim 19, wherein said application comprises a plurality of phone numbers associated with said plurality of second users, and when said application generates said alert, said application
determines whether one or more of a data service and a voice service is available via said computer,
wherein when said data service is available, said application
transmits said alert to said server via said processor and said transmitter,
said server receives said alert, and when said server receives said alert,
said server selects a second user from said at least one second user associated with said first user, and transmits a notification to said second user, and,
wherein when said voice service is available,
said application selects a phone number from said plurality of phone numbers associated with said at least one second user and initiates a voice call to said at least one second user.

21. The personal security system of claim 20, wherein
said server selects said second user from said at least one second user and wherein said application selects said phone number from said plurality of phone numbers associated with said at least one second user
based on which of said at least one second user is deemed most likely to be able to respond to said notification,
wherein which of said at least one second user is deemed most likely to be able to respond to said notification is based on one or more parameters selected from
a location of said first user,
a time of day,
a location of said at least one second user, and,
a presence or absence of said at least one second user located within a predetermined vicinity surrounding said first user.

22. The personal security system of claim 21, wherein when said application selects said second user from said at least one second user or when said application selects said phone number from said plurality of phone numbers associated with said at least one second user, said application transmits one or more of geographic coordinates, a map or address of a location of the first user.

23. The personal security system of claim 19, wherein said one or more features further comprise a third key obtained from said first user,
wherein said application recognizes said third key, and when said application recognizes said third key word,
said application executes on said processor to generate an alert as a notification to enable hands free calling.

24. The personal security system of claim 23, wherein based on said notification, said application selects a phone number from said plurality of phone numbers associated with said at least one second user and automatically initiates a voice call to said at least one second user via said processor without manual interaction with said computer by said first user.

25. The personal security system of claim 23, wherein based on said notification, said application automatically transmits a message to at least one external device via said processor.

26. The personal security system of claim 1, further comprising a server coupled with said computer, wherein said application bidirectionally communicates with said server, and wherein said application further executes on said processor to
record video data, audio data, or both video and audio data via said computer, and,
transmit at least a portion of said video data, audio data or both said video data and said audio data to said server via said processor.

27. The personal security system of claim 26, wherein said at least a portion of said video data, audio data or both said video data and said audio data comprises data collected a predetermined time interval prior to said generate said alert.

28. The personal security system of claim 27, wherein said computer further comprising a user interface, and wherein said alert remains active on said computer until a passcode is entered via said user interface.

29. The personal security system of claim 1, wherein said processor is further configured to accept a timed alert obtained from said first user, wherein said timed alert is configured between a first location and a second location, or configured with a time frame, or both and wherein said application further executes on said processor to accept a safe word from said first user, such that
said time alert is generated
when said application detects wherein said first user is at said second location for a predetermined period of time, or
when said time frame has expired for a predetermined period of time, or
both, and,
said timed alert is not generated when the safe word is obtained from said first user.

30. The personal security system of claim 1, further comprising an accelerometer, or tactile sensor or both, wherein said application further executes on said processor to
collect movement data, tactile data or both from said accelerometer, or tactile sensor or both,
extract one or more features from said movement data, said tactile data or both,
wherein said one or more features comprise at least one thumb print, tap, or shake obtained from said first user on said computer,
recognize a gesture from said at least one thumb print, tap, or shake, and, generate an alert upon recognition of said gesture.
